(19) United States
(12) Patent Application Publication
(10) Pub. No.: US 2026/0032747 A1
(43) Pub. Date: Jan. 29, 2026

(54) METHODS AND APPARATUSES FOR SIMULTANEOUS TRANSMISSION ON MULTIPLE PATHS

(71) Applicant: LENOVO (BEIJING) LIMITED, Beijing (CN)

(72) Inventors: Ran Yue, Beijing (CN); Lianhai Wu, Beijing (CN); Jing Han, Beijing (CN); Haiming Wang, Beijing (CN); Min Xu, Beijing (CN)

(21) Appl. No.: 18/998,206

(22) PCT Filed: Jul. 25, 2022
(86) PCT No.: PCT/CN2022/107644

§ 371 Date: Jan. 24, 2025

(51) Int. Cl. H04W 76/15; H04L 5/00

(52) U.S. Cl. CPC H04W 76/15; H04L 5/0055

(57) ABSTRACT

The present application relates to methods and apparatuses for simultaneous transmission on multiple paths. One embodiment of the present disclosure provides a relay user equipment (UE), which includes: a transceiver: and a processor coupled with the transceiver and configured to: receive configuration information associated with a data radio bearer (DRB) of a remote UE; and receive, from at least one of a base station (BS) or from the remote UE, a first indication indicating activation or deactivation of a simultaneous transmission on multiple paths of the DRB of the remote UE, wherein the multiple paths include at least a direct path and an indirect path.

### TECHNICAL FIELD

The present disclosure relates to wireless communication technology, and especially to methods and apparatuses for simultaneous transmission on multiple paths.

### BACKGROUND OF THE INVENTION

Simultaneous transmission on multiple paths can improve the performance of wireless network. For example, by performing the same transmission on multiple paths, the reliability is enhanced, and by performing different transmission on multiple paths, the throughput is improved.

Therefore, it is desirable to provide solutions for simultaneous transmission on multiple paths.

### SUMMARY

One embodiment of the present disclosure provides a relay user equipment (UE), which includes: a transceiver; and a processor coupled with the transceiver and configured to: receive configuration information associated with a data radio bearer (DRB) of a remote UE; and receive, from at least one of a base station (BS) or from the remote UE, a first indication indicating activation or deactivation of a simultaneous transmission on multiple paths of the DRB of the remote UE, wherein the multiple paths include at least a direct path and an indirect path.

In some embodiments, the first indication indicates at least one of the following: an identifier of a remote UE; an identifier of a DRB; an identifier of a path; an identifier of a radio link control (RLC); or an identifier of a logical channel.

In some embodiments, the first indication is associated with at least one of a DRB configured to the direct path or associated with a DRB configured to the indirect path.

In some embodiments, the first indication includes at least one of the following: a radio resource control (RRC) message; an information element (IE) in a RRC message; downlink control information (DCI); a media access control control element (MAC CE); a control protocol data unit (PDU) of a sidelink relay adaptation protocol (SRAP) layer; or a control PDU of an RLC layer.

In some embodiments, the processor is further configured to: transmit the control PDU of the SRAP layer to the remote UE; or assemble, reassemble, generate, or regenerate the control PDU of the SRAP layer, and transmit the assembled, reassembled, generated or regenerated control PDU of the SRAP layer to the remote UE.

In some embodiments, in the case the first indication includes the MAC CE or the control PDU of the RLC layer, the processor is further configured to: generate a second indication based on the first indication, wherein the second indication indicating activation or deactivation of a simultaneous transmission on multiple paths of the DRB of the remote UE and the second indication is identifiable by the remote UE; and transmit the second indication to the remote UE via an interface between the remote UE and the relay UE.

In some embodiments, the processor is further configured to: transmit a response to the first indication, wherein the response includes at least one of the following: a confirmation of the activation or deactivation; a message; an acknowledge (ACK); or a hybrid automatic repeat request acknowledge (HARQ ACK); or wherein the response includes at least one of the following: a rejection of the activation or deactivation; a message; an negative-acknowledgement (NACK); or a hybrid automatic repeat request negative-acknowledgement (HARQ NACK).

Still another embodiment of the present disclosure provides a remote UE, which includes: a transceiver; and a processor coupled with the transceiver and configured to: receive configuration information associated with a simultaneous transmission on multiple paths; and receive, from at least one of a BS or from a relay UE, a first indication indicating activation or deactivation of a simultaneous transmission on multiple paths of a DRB, wherein the multiple paths include at least a direct path and an indirect path.

In some embodiments, the first indication indicates at least one of the following: an identifier of a remote UE; an identifier of a DRB; an identifier of a path; an identifier of a RLC; or an identifier of a logical channel.

In some embodiments, the first indication includes at least one of the following: a radio RRC message; an IE in a RRC message; DCI; a MAC CE; a control PDU of a SRAP layer; or a control PDU of an RLC layer.

In some embodiments, the first indication is associated with at least one of a DRB configured to the direct path or associated with a DRB configured to the indirect path.

In some embodiments, in the case that the first indication is received from the BS, the processor is further configured to: transmit, to a rely UE, a second indication indicating activation or deactivation of a simultaneous transmission on multiple paths of the DRB.

In some embodiments, the processor is further configured to: receive, from the rely UE, a response to the second indication, wherein the response includes at least one of the following: a confirmation of the activation or deactivation; a message; an ACK; or a HARQ ACK; or wherein the response includes at least one of the following: a rejection of the activation or deactivation; a message; a NACK; or a HARQ NACK.

Another embodiment of the present disclosure provides a Base Station (BS), which includes: a transceiver; and a processor coupled with the transceiver and configured to: transmit configuration information associated with a DRB of a remote UE; and transmit, to at least one of the remote UE or a relay UE, a first indication indicating activation or deactivation of a simultaneous transmission on multiple paths of the DRB of the remote UE, wherein the multiple paths include at least a direct path and an indirect path.

In some embodiments, the first indication indicates at least one of the following: an identifier of a remote UE; an identifier of a DRB; an identifier of a path; an identifier of a RLC; or an identifier of a logical channel.

In some embodiments, the first indication includes at least one of the following: a radio RRC message; an IE in a RRC message; DCI; a MAC CE; a control PDU of a SRAP layer; or a control PDU of an RLB layer.

In some embodiments, the first indication is associated with at least one of a DRB configured to the direct path or associated with a DRB configured to the indirect path.

In some embodiments, the processor is further configured to: perform a same transmission or different transmissions on the multiple paths to the remote UE.

Yet another embodiment of the present disclosure provides a method performed by a relay UE, which includes: receiving configuration information associated with a DRB of a remote UE; and receiving, from at least one of a BS or from the remote UE, a first indication indicating activation or deactivation of a simultaneous transmission on multiple paths of the DRB of the remote UE, wherein the multiple paths include at least a direct path and an indirect path.

Yet another embodiment of the present disclosure provides a method performed by a remote UE, which includes: receiving configuration information associated with a DRB; and receiving, from at least one of a BS or from a relay UE, a first indication indicating activation or deactivation of a simultaneous transmission on multiple paths of the DRB, wherein the multiple paths include at least a direct path and an indirect path.

Still another embodiment of the present disclosure provides a method performed by a BS, which includes: transmitting configuration information associated with a DRB of a remote UE; and transmitting, to at least one of the remote UE or a relay UE, a first indication indicating activation or deactivation of a simultaneous transmission on multiple paths of the DRB of the remote UE, wherein the multiple paths include at least a direct path and an indirect path.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system according to some embodiments of the present disclosure.

FIG. 2 illustrates a user plane (UP) protocol stack for L2 UE-to-Network relay according to some embodiments of the present disclosure.

FIG. 3 illustrates a control plane (CP) protocol stack for L2 UE-to-Network relay according to some embodiments of the present disclosure.

FIG. 4 illustrates a method performed by a relay UE for simultaneous transmission on multiple paths according to some embodiments of the present disclosure.

FIG. 5 illustrates a method performed by a remote UE for simultaneous transmission on multiple paths according to some embodiments of the present disclosure.

FIG. 6 illustrates a method performed by a BS for simultaneous transmission on multiple paths according to some embodiments of the present disclosure.

FIG. 7 illustrates a simplified block diagram of an apparatus for simultaneous transmission on multiple paths according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order as shown or in a sequential order, or that all illustrated operations need be performed, to achieve desirable results; sometimes one or more operations can be skipped. Further, the drawings can schematically depict one or more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

Reference will now be made in detail to some embodiments of the present disclosure, examples of which are illustrated in the accompanying drawings. To facilitate understanding, embodiments are provided under specific network architecture and new service scenarios, such as a cellular telephone network, a time division multiple access (TDMA)-based network, a code division multiple access (CDMA)-based network, an orthogonal frequency division multiple access (OFDMA)-based network, a LTE network, a 3^{rd} generation partnership project (3GPP)-based network, LTE, LTE-Advanced (LTE-A), 3GPP 4G, 3GPP 5G NR, 3GPP Release 16 and onwards, a satellite communications network, a high altitude platform network, and so on. The wireless communications system 100 may implement some other open or proprietary communication protocols, for example, IEEE 802.11 family, WiMAX, among other protocols. It is contemplated that along with the developments of network architectures and new service scenarios, all embodiments in the present disclosure are also applicable to similar technical problems; and moreover, the terminologies recited in the present disclosure may change, which should not affect the principle of the present disclosure.

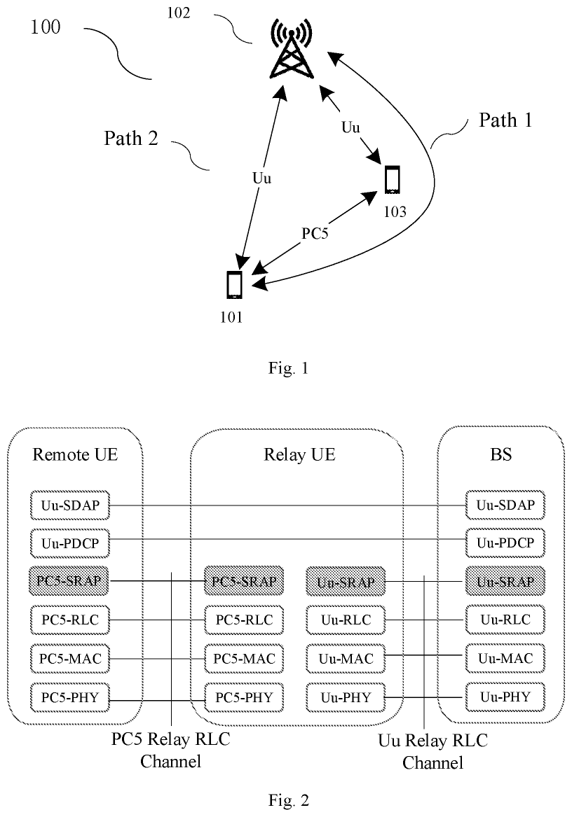

FIG. 1 depicts a wireless communications system in accordance with some embodiments of the present disclosure.

Referring to FIG. 1, the wireless communications system 100 may include at least one remote UE 101, at least one relay UE 103, and at least one BS 102. Although only one remote UE 101, one BS 102, and one relay UE 103 are depicted in FIG. 1, it is contemplated that any number of remote UEs, relay UEs, and BSs may be included in the wireless communications system 100.

In some embodiments of the present disclosure, the remote UE 101 may be devices in different forms or having different capabilities. According to some embodiments of the present disclosure, the remote UE 101 may include or may be referred to as computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the remote UE 101 may include or may be referred to as portable wireless communication devices, such as smart phones, cellular telephones, flip phones, or any other device that is capable of transmitting and receiving information. In some embodiments, the remote UE 101 may include or may be referred to as wearable devices, such as smart watches, fitness bands, optical head-mounted displays, or the like. Moreover, the remote UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In some embodiments of the present disclosure, the BS 102 may be referred to as an access point, an access terminal, a base, a base unit, a macro cell, a Node B, an enhanced Node B, an evolved Node B, a next generation Node B (gNB), a Home Node B, a relay node, or a device, or described using other terminology used in the art. The BS 102 is generally a part of a radio access network that may include one or more controllers communicably coupled to one or more corresponding BS 102.

In some embodiments of the present disclosure, the relay UE 103 may be a UE-to-Network (U2N) relay UE. In some embodiments, the relay UE may also be a UE-to-UE (U2U) relay UE. In some other embodiments, the relay UE may be a U2N and U2U relay UE. The relay UE may receive data transmission from the BS 102, and forward the data transmission to UE 101, or identify the data transmission from the BS 102, and (re)assemble or (re)generate the data transmission then transmit the (re)assembled or (re)generated data transmission to UE 101. Similarly, the relay UE may receive data transmission from UE 101, and forward the data transmission to the BS 102, or identify the data transmission from UE 101, and (re)assemble or (re)generate the data transmission then transmit the (re)assembled or (re)generated data transmission to the BS 102.

For the data transmission between the UE 101 and the BS 102, there may be two paths. The UE 101 and the BS 102 may perform data transmission via a direct path, i.e. Path #2 as shown in FIG. 1, and DRB #2 may be configured to be transmitted on Path #2. The UE 101 and the BS 102 may perform data transmission via an indirect path, i.e. Path #1 as shown in FIG. 1, in which the relay UE 103 is included, and DRB #1 may be configured to be transmitted on Path #1 and the UE 101 is the remote UE of relay UE 103. The indirect path may be a type of UE-to-Network transmission path, where data is forwarded via a U2N Relay UE between a U2N Remote UE and the network. The indirect path may also be a type of UE-UE inter-connection transmission path, where data is forwarded via another UE. And the interface between the two UEs may benon-3GPP specified or 3GPP specified. The UE-UE inter-connection may be ideal or non-ideal. For example, the UE-UE may be a smart phone and a smart watch. Further, the two devices may belong to one person or different persons.

To simplify the description, the present disclosure refers the UE 101 as the remote UE when the UE 101 communicates via the direct path or indirect path. The UE 101 may be a U2N remote UE, and may communicate with the network via a relay UE, for example, the relay UE 103. For example, the UE 101 may use the Uu interface to perform data transmission with the BS 102, and may use the PC5 interface with the relay UE 103. The U2N relay UE may be a UE that provides functionality to support connectivity to the network for the U2N remote UE(s). For example, the relay UE 103 may use the Uu interface to perform data transmission with the BS 102, and may use the PC5 interface with the remote UE 101.

The remote UE 101 may perform simultaneous transmission on multiple paths, simultaneous transmission of DRB(s), simultaneous transmission of logical channel(s), simultaneous transmission of RLC entity(ies), simultaneous transmission of traffic(s), PDCP duplication, or packet duplication.

Hereinafter in the present disclosure, the expressions “simultaneous transmission on multiple paths”, “simultaneous transmission of DRB(s)”, “simultaneous transmission of logical channel(s)”, “simultaneous transmission of RLC entity(ies)”, “simultaneous transmission of traffic(s)”, “PDCP duplication”, or “packet duplication” may be used interchangeably where appropriate.

FIG. 2 illustrates a user plane (UP) protocol stack for L2 UE-to-Network relay according to some embodiments of the present disclosure.

Three components are included, a remote UE, for example, the remote UE 101 in FIG. 1, a relay UE, such as the relay UE 103 in FIG. 1, and a BS, e.g. the BS 102 in FIG. 1. The user plane protocol stack for the remote UE may include Uu-SDAP, Uu-PDCP, PC5-SRAP, PC5-RLC, PC5-MAC and PC5-PHY. The user plane protocol stack for the relay UE may include PC5-SRAP, PC5-RLC, PC5-MAC, PC5-PHY, Uu-SRAP, Uu-RLC, Uu-MAC, Uu-PHY. The user plane protocol stack for the BS may include Uu-SDAP, Uu-PDCP, Uu-SRAP, Uu-RLC, Uu-MAC, Uu-PHY. The channel between the remote UE and the relay UE is PC5 relay RLC channel, and the channel between the relay UE and the BS is Uu relay RLC channel

The SRAP sublayer is placed above the RLC sublayer for both CP and UP at both the PC5 interface and the Uu interface. The Uu SDAP, PDCP and RRC are terminated between a L2 U2N remote UE and a BS, while SRAP, RLC, MAC and PHY are terminated in each hop (i.e. the link between L2 U2N remote UE and L2 U2N relay UE and the link between L2 U2N relay UE and the BS).

For L2 U2N relay, the SRAP sublayer over PC5 hop is only for the purpose of bearer mapping. The SRAP sublayer is not present over PC5 hop for relaying the L2 U2N remote UE's message on BCCH and PCCH. For L2 U2N remote UE's message on SRB0, the SRAP sublayer is not present over PC5 hop, but the SRAP sublayer is present over Uu hop for both DL and UL.

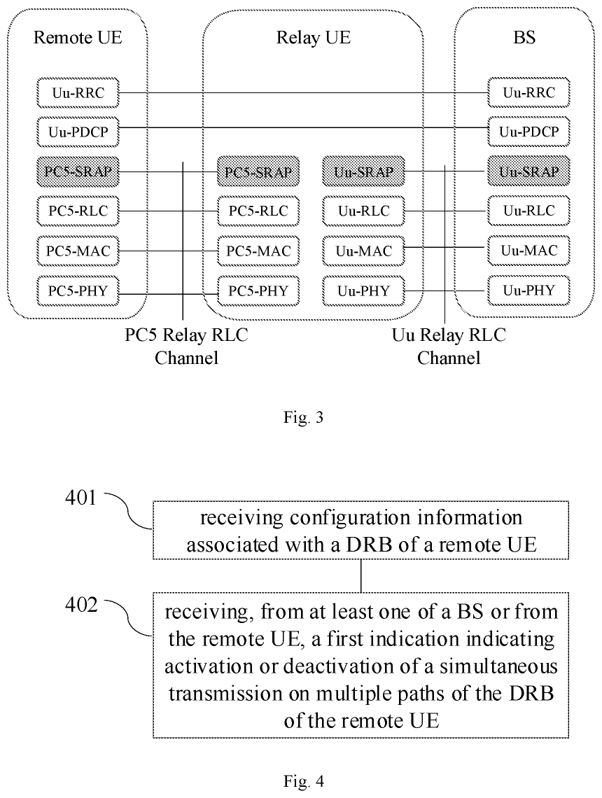

FIG. 3 illustrates a control plane protocol stack for L2 UE-to-Network relay according to some embodiments of the present disclosure.

Three components are included, a remote UE, for example, the remote UE 101 in FIG. 1, a relay UE, such as the relay UE 103 in FIG. 1, and a BS, e.g. BS 102 in FIG. 1. The control plane protocol stack for the remote UE may include Uu-RRC, Uu-PDCP, PC5-SRAP, PC5-RLC, PC5-MAC and PC5-PHY. The control plane protocol stack for the relay UE may include PC5-SRAP, PC5-RLC, PC5-MAC, PC5-PHY, Uu-SRAP, Uu-RLC, Uu-MAC, Uu-PHY. The control plane protocol stack for the BS may include Uu-RRC, Uu-PDCP, Uu-SRAP, Uu-RLC, Uu-MAC, Uu-PHY. The channel between the remote UE and the relay UE is PC5 relay RLC channel, and the channel between the relay UE and the BS is Uu relay RLC channel

For L2 U2N relay, for uplink:
The Uu SRAP sublayer supports UL bearer mapping between ingress PC5 relay RLC channels for relaying and egress Uu relay RLC channels over the L2 U2N relay UE Uu interface. For uplink relaying traffic, the different end-to-end RBs (SRBs or DRBs) of the same remote UE and/or different remote UEs can be multiplexed over the same Uu relay RLC channel;
The Uu SRAP sublayer supports L2 U2N remote UE identification for the UL traffic. The identity information of L2 U2N remote UE Uu Radio Bearer and a local remote UE ID are included in the Uu SRAP header at UL in order for the BS to correlate the received packets for the specific PDCP entity associated with the right Uu Radio Bearer of a remote UE;
The PC5 SRAP sublayer at the L2 U2N remote UE supports UL bearer mapping between remote UE Uu Radio Bearers and egress PC5 relay RLC channels.

For L2 U2N relay, for downlink:
The Uu SRAP sublayer supports DL bearer mapping at the BS to map end-to-end radio bearer (e.g. SRB, or DRB) of the remote UE into Uu relay RLC channel over the relay UE Uu interface. The Uu SRAP sublayer supports DL bearer mapping and data multiplexing between multiple end-to-end Radio Bearers (SRBs or DRBs) of a L2 U2N remote UE and/or different L2 U2N remote UEs and one Uu relay RLC channel over the relay UE Uu interface.

The Uu SRAP sublayer supports remote UE identification for DL traffic. The identity information of remote UE Uu radio bearer and a local remote UE ID are included into the Uu SRAP header by the BS at DL in order for relay UE to map the received packets from remote UE Uu radio bearer to its associated PC5 relay RLC channel.

The PC5 SRAP sublayer at the relay UE supports DL bearer mapping between ingress Uu relay RLC channels and egress PC5 relay RLC channels;
The PC5 SRAP sublayer at the remote UE correlates the received packets for the specific PDCP entity associated with the right Uu radio bearer of a remote UE based on the identity information included in the Uu SRAP header.

A local remote UE ID is included in both PC5 SRAP header and Uu SRAP header. L2 U2N relay UE is configured by the BS with the local remote UE ID to be used in SRAP header. Remote UE obtains the local remote ID from the BS via Uu RRC messages including RRCSetup, RRCReconfiguration, RRCResume and RRCReestablishment. Uu DRB(s) and Uu SRB(s) are mapped to different PC5 relay RLC channels and Uu relay RLC channels in both PC5 hop and Uu hop.

It is the BS's responsibility to avoid collision on the usage of local remote UE ID. The BS may update the local remote UE ID by sending the updated local remote ID via RRCReconfiguration message to the relay UE. The serving BS can perform local remote UE ID update independent of the PC5 unicast link L2 ID update procedure.

There might be some issues for achieving the multi-path transmission via a direct path and an indirect path.

Issue 1: how to indicate the activation or deactivation of the simultaneous transmission on multiple paths to the relay UE.

In some cases, the relay UE, e.g. the relay UE 103, may not be aware whether a simultaneous transmission on multiple paths of the remote UE's DRB (e.g. the DRB of the UE 101) is activated or not. In this case, the relay UE may consider that simultaneous transmission on multiple paths of the remote UE's DRB is activated, and may monitor the resources for the relevant transmission, to avoid missing any potential reception. However, in the case that the simultaneous transmission on multiple paths of the remote UE's DRB is not activated, or is deactivated, the relay UE may still monitor the resources, which may cause unnecessary power consuming.

Accordingly, it is beneficial to indicate the activation or deactivation of a simultaneous transmission on multiple paths of the remote UE's DRB to the relay UE.

Issue 2: how to activate or deactivate the simultaneous transmission on multiple paths of the remote UE.

In general, the activation or deactivation may be achieved by the activation or deactivation MAC CE. The signalling (i.e. the activation or deactivation MAC CE) may control the same side as the sender.

In Rel-18 multi-path scenario, a bearer may be configured to a path. For example, a bearer, e.g. DRB #1 may be configured to the indirect path, i.e. Path #1 in FIG. 1, and another bearer, e.g. DRB #2 may be configured to the direct path, i.e. Path #2 in FIG. 1. Both DRB #1 and DRB #2 may be configured with simultaneous transmission on multiple paths. The simultaneous transmission on multiple paths of DRB #2 may be activated or deactivated by the activation or deactivation MAC CE via the Uu interface between the BS and the remote UE. However, regarding the simultaneous transmission on multiple paths of DRB #1, which is configured to the indirect path, i.e. Path #1 in FIG. 1, and there is no available MAC CE or signaling to activate or deactivate the simultaneous transmission on multiple paths of DRB #1.

Therefore, it is advantages to provide solutions to solve the above issues. It should be noted that the solutions proposed in the present disclosure may apply to any suitable wireless networks, for example, a wireless network including simultaneous transmission on multiple paths, wherein a transmission on an indirect path of the multiple paths is accomplished via a U2N relay UE, a U2U relay UE, or UE-UE inter-connection transmission, or the like. When the UE-UE inter-connection transmission is applied and the interface between UEs is not 3GPP specified, it is up to UE implementation to accomplish the procedures over the PC5 interface which is mentioned in the present disclosure.

In the present disclosure, the UE capability may support the transmission on multiple paths, or the UE capability may support the transmission on multiple paths as a remote UE, or the UE capability may support the simultaneous transmission on multiple paths, or the UE capability may support the simultaneous transmission on multiple paths as a remote UE. The UE may report the UE capability to the BS or to the network. Alternatively, the UE may be a specific type of UE, such as R-18 UE, or a Rel-18 remote UE, or the like, and the BS may consider such type of UE supports the transmission on multiple paths, thus the specific type of UE may not need to report the UE capability to the BS.

### Solution 1

Solution 1 aims to solve the issue of how to indicate the activation or deactivation of the simultaneous transmission on multiple paths to the relay UE.

### Solution 1-1

In solution 1-1, the BS may transmit an indication to the relay UE, to indicate the activation or deactivation of the configured simultaneous transmission on multiple paths of the remote UE's DRB(s), or indicate the configured simultaneous transmission on multiple paths of the remote UE's DRB(s) may be activated or deactivated after a time duration. The length of the time duration may be indicated in the indication, or may be a fixed or preconfigured value.

The indication may be at least one of the following: a RRC message, an IE in a RRC message, a RRC signalling, a MAC CE, a control PDU of SRAP layer, a control PDU of an RLC layer, or DCI carried by a PDCCH transmission.

The indication may indicate the activation or deactivation of the simultaneous transmission on multiple paths per remote UE per DRB. In other words, the indication may indicate the activation or deactivation of the simultaneous transmission on multiple paths for specific remote UE(s) and for a specific DRB(s). Accordingly, the indication may indicate one or more IDs of one or more remote UEs, or one or more IDs of one or more DRBs, or both. For example, the indication may indicate: UE 101, DRB #1; the indication may indicate: UE A, DRB #2; or the indication may indicate: UE B, all configured DRBs; etc. In some other embodiments, the indication may also indicate one or more IDs of one or more paths, one or more IDs of one or more RLCs, one or more IDs of one or more LCHs, etc.

At the relay UE side, after receiving the indication, in the case that the indication indicates an activation of the simultaneous transmission on multiple paths of a DRB of a remote UE, the relay UE may monitor potential transmission of the remote UE. That is, any potential transmission from the remote UE to the BS via the indirect path, and any potential transmission from the BS to the remote UE via the indirect path.

In some other embodiments, after receiving the indication indicating an activation of the simultaneous transmission on multiple paths of a DRB of a remote UE, because the activation of the simultaneous transmission on multiple paths of a DRB of a remote UE for the direct path may also be transmitted over the indirect path, the relay UE may determine whether the simultaneous transmission on the indirect path of the remote UE's DRB(s) is activated. When the relay UE determines that the simultaneous transmission on the indirect path of the remote UE's DRB(s) is activated, the relay UE may monitor potential transmission of the remote UE.

In some embodiments, the relay UE may respond the indication from the BS, the response may be at least one of the following: a confirmation of the activation or deactivation; a message (i.e. an RRC message); an ACK (i.e. an RLC ACK or a PDCP ACK); or a HARQ ACK. Alternatively, the response may also be at least one of the following: a rejection of the activation or deactivation; a message (i.e. an RRC message); a NACK (i.e. an RLC NACK or a PDCP NACK); or a HARQ NACK.

In the case that the indication indicates a deactivation of the simultaneous transmission on multiple paths of a DRB of a remote UE, the relay UE may determine whether the simultaneous transmission on the indirect path of the remote UE's DRB(s) is deactivated, since the deactivation of the simultaneous transmission on multiple paths of a DRB of a remote UE for the direct path may be transmitted over the indirect path. When the relay UE determines that the simultaneous transmission on the indirect path of the remote UE's DRB(s) is deactivated, the relay UE may stop monitoring the resource pool used by the remote UE.

Alternatively, the BS may not transmit an indication to the relay UE, and may configure or release the resources on the PC5 interface. The configuring of resources on the PC5 interface may implicitly suggest that the simultaneous transmission on indirect path of the remote UE's DRB(s) is activated. The release of the resources on the PC5 interface may implicitly suggest that the simultaneous transmission on indirect path of the remote UE's DRB(s) is deactivated.

### Solution 1-2

The BS or the relay UE may configure resources on the PC5 interface to the remote UE, such that the remote UE may transmit necessary information. Alternatively, the BS may configure resources on the PC5 interface to the relay UE, such that the relay UE may transmit the necessary information.

At the remote UE side, it may receive the first indication from the BS, which may indicate the activation or deactivation of the simultaneous transmission on multiple paths per DRB. That is, the first indication may include one or more IDs of one or more DRBs, such as: DRB #1, DRB #2, etc. In some other cases, the first indication may also include one or more IDs of one or more paths, one or more IDs of one or more RLCs, one or more IDs of one or more LCHs, etc. The first indication may be at least one of the following: a RRC message, an IE in a RRC message, a RRC signalling, a MAC CE, a control PDU of SRAP layer, a control PDU of an RLC layer, or DCI carried on the PDCCH transmission.

Based on the first indication, the remote UE may transmit the second indication to a relay UE, the second indication may indicate one of the following:
a) the activation or deactivation of the configured simultaneous transmission on multiple paths of the remote UE's DRB(s), or activation or deactivation of the configured simultaneous transmission on which path, or activation or deactivation of the configured simultaneous transmission on which path of the remote UE's DRB(s);
b) the configured simultaneous transmission on multiple paths of the remote UE's DRB(s) may be activated or deactivated after a time duration, or activation or deactivation of the configured simultaneous transmission on which path after a time duration, or activation or deactivation of the configured simultaneous transmission on which path of the remote UE's DRB(s) after a time duration;
c) a request for activation or deactivation of a simultaneous transmission on multiple paths of the DRB of the remote UE, or a request for activation or deactivation of a simultaneous transmission on which path, or a request for activation or deactivation of a simultaneous transmission on which path of the DRB of the remote UE; or
d) a request for activation or deactivation of a simultaneous transmission on multiple paths of the DRB of the remote UE after a time duration, or a request for activation or deactivation of a simultaneous transmission on which path after a time duration, or a request for activation or deactivation of a simultaneous transmission on which path of the DRB of the remote UE after a time duration.

The length of the time duration may be indicated in the second indication, or may be a fixed value or a preconfigured value.

The second indication may include one or more IDs of one or more DRBs corresponding to the activated or deactivated simultaneous transmission on multiple paths, such as DRB #1, DRB #2, etc. In some other cases, the second indication may also include one or more IDs of one or more paths, one or more IDs of one or more RLCs, one or more IDs of one or more LCHs, etc.

In some embodiments, the relay UE may respond the second indication from the remote UE, the response may be at least one of the following: a confirmation of the activation or deactivation; a message (i.e. an RRC message); an ACK (i.e. an RLC ACK or a PDCP ACK); or a HARQ ACK. Alternatively, the response may also be at least one of the following: a rejection of the activation or deactivation; a message (i.e. an RRC message); a NACK (i.e. an RLC NACK or a PDCP NACK); or a HARQ NACK.

### Solution 2

Solution 2 aims to solve the issue of how to activate or deactivate the simultaneous transmission on multiple paths of the remote UE.

### Solution 2-1

The present disclosure proposes that the activation or deactivation of simultaneous transmission on multiple paths corresponding to a DRB configured on a path may be indicated by indication(s) transmitted via any path. For example, the activation or deactivation of simultaneous transmission on multiple paths corresponding to a DRB configured on Path #1 may be indicated by indication(s) transmitted via any one of Path #1, Path #2, Path #3, etc.

In some other embodiments, the activation or deactivation of simultaneous transmission on multiple paths corresponding to a DRB configured on an indirect path may be indicated by indication(s) transmitted via a direct path; and the activation or deactivation of simultaneous transmission on multiple paths corresponding to a DRB configured on a direct path may not be indicated by indication(s) transmitted via an indirect path. That is, the activation or deactivation of simultaneous transmission on multiple paths corresponding to a DRB configured on any path (including both the direct path and the indirect path) may only be indicated by indication(s) transmitted via a direct path.

In some other embodiments, the activation or deactivation of simultaneous transmission on multiple paths corresponding to a DRB configured on a direct path may be indicated by indication(s) transmitted via an indirect path; and the activation or deactivation of simultaneous transmission on multiple paths corresponding to a DRB configured on an indirect path may not be indicated by indication(s) transmitted via a direct path. That is, the activation or deactivation of simultaneous transmission on multiple paths corresponding to a DRB configured on any path (including both the direct path and the indirect path) may only be indicated by indication(s) transmitted via an indirect path.

Hereinafter in the present disclosure, the direct path may be one of the direct paths (when more than one direct path is configured), and the indirect path may be one of the indirect paths (when more than one indirect path is configured).

In some embodiments, the activation or deactivation of simultaneous transmission on multiple paths corresponding to a DRB configured on a path may be indicated by indication(s) transmitted via two or more paths, and the two or more paths may be any two or more paths among the multiple paths.

The BS may ensure that the ID(s) of DRB is not repeatedly configured on different paths. For example, the activation or deactivation of simultaneous transmission on multiple paths corresponding to DRB #1, DRB #2 and DRB #3 may be indicated by indication(s) transmitted via Path #1, and the activation or deactivation of simultaneous transmission on multiple paths corresponding to DRB #4, DRB #5 and DRB #6 may be indicated by indication(s) transmitted via Path #2. The BS may ensure, for example, DRB #1 is only configured on Path #1, not on Path #2.

The indication(s) may include at least one of the following: a RRC message; an IE in a RRC message, DCI, a MAC CE, a PDU of a SRAP layer, or a control PDU of an RLC layer. The indication(s) may indicate at least one of the following: one or more identifiers of one or more remote UEs; one or more identifiers of a DRB; one or more identifiers of one or more paths; one or more identifiers of one or more RLCs; or one or more identifiers of one or more logical channels.

### Solution 2-2

The present disclosure proposes to introduce a new indication, such as a new MAC CE, or a new LCID, that may indicate one or more DRBs correspond to which path, which RLC, or which logical channel. For example, the indication may indicate that DRB #1 and DRB #2 correspond to path #1; and DRB #3 and DRB #4 correspond to path #2. The MAC CE may indicate at least one of the following: one or more IDs of one or more DRBs, one or more IDs of one or more paths, one or more IDs of one or more RLCs; or one or more IDs of one or more logical channels. The indication may also indicate one or more IDs of one or more remote UEs.

The new MAC CE or the new LCID may be transmitted via any path, for example, Path #1, Path #2, a direct path, an indirect path, etc. Or the new MAC CE or the new LCID may only be transmitted via one of the direct paths. Or the new MAC CE or the new LCID may only be transmitted via one of the indirect paths.

The BS may transmit the new MAC CE or the new LCID to the remote UE via the Uu interface, and the remote UE is aware that the DRB indicated by the MAC CE corresponds to which path. The BS may also transmit the new MAC CE or the new LCID to the relay UE via the Uu interface, and the relay UE is aware that the DRB indicated by the MAC CE corresponds to which path. The BS may also transmit the new MAC CE or the new LCID to the remote UE via the indirect path, and the relay UE may transmit the new MAC CE or the new LCID to the remote UE.

Regarding the transmission of the MAC CE via the indirect path, the detailed transmission manner is described in the following solution 2-4.

### Solution 2-3

In this solution, it is proposed that a control PDU in SRAP layer may be used to indicate: 1) the activation or deactivation of the simultaneous transmission on multiple paths of a remote UE's DRB(s); and 2) the identifier(s) of DRB(s) associated with a path (including a direct path, an indirect path, or any path).

In particular, the RRC layer of the BS may trigger or may indicate the control PDU of the SRAP layer to generate the control PDU of the SRAP layer. The BS then may transmit the control PDU of the SRAP layer to the relay UE via the Uu interface.

At relay UE side, the relay UE may identify the control PDU of the SRAP layer, such as, identifying the identifier(s) of the DRB(s), identifying of the activation or deactivation status, etc. The relay UE may assemble, reassemble, generate, or regenerate the control PDU of the SRAP layer, and transmit the assembled, or reassembled, generated, or regenerated control PDU of the SRAP layer to the remote UE via the PC5 interface. In the present disclosure, the expressions “assemble”, “reassemble”, “generate”, or “regenerate” may be used interchangeably where appropriate, and the expressions “assembled”, “reassembled”, “generated”, or “regenerated” may also be used interchangeably where appropriate.

Alternatively, the relay UE may forward the control PDU of the SRAP layer to the remote UE via the PC5 interface.

In some other embodiments, the control PDU in SRAP layer may further indicate at least one of the following: one or more IDs of one or more remote UEs, one or more IDs of one or more DRBs, one or more IDs of one or more paths, one or more IDs of one or more RLCs; or one or more IDs of one or more logical channels.

### Solution 2-4

The MAC layer or the RLC layer of the relay UE may receive the first indication of activation or deactivation of simultaneous transmission on multiple paths of the remote UE's DRB(s) from the BS. The first indication of activation or deactivation of simultaneous transmission on multiple paths of the remote UE's DRB(s) may be a type of MAC CE, such as the existing MAC CE, or a new MAC CE. The MAC layer of the relay UE may receive the MAC CE from the BS. Alternatively, the first indication may be new RLC control PDU, or the like. The first indication may be RLC control PDU, and the RLC layer of the relay UE may receive the RLC control PDU from the BS.

The first indication may indicate: the ID of the remote UE and the corresponding ID(s) of the DRB(s). The ID of the remote UE and the ID(s) of the DRB(s) may be assembled with the first indication. In some embodiments, the first indication may further indicate at least one of the following: one or more IDs of one or more remote UEs, one or more IDs of one or more DRBs, one or more IDs of one or more paths, one or more IDs of one or more RLCs; or one or more IDs of one or more logical channels.

After receiving the first indication, the relay UE may generate a second indication based on the first indication. The second indication may be identifiable by the remote UE. The second indication may indicate activation or deactivation of a simultaneous transmission on multiple paths of the DRB of the remote UE. The relay UE may transmit the second indication to the remote UE via the PC5 interface. The second indication may be a MAC CE or a RLC control PDU. In some embodiments, the second indication may further indicate at least one of the following: one or more IDs of one or more remote UEs, one or more IDs of one or more DRBs, one or more IDs of one or more paths, one or more IDs of one or more RLCs; or one or more IDs of one or more logical channels.

The second indication may be generated in the following way: after receiving the first indication, such as a Uu MAC CE (or a Uu RLC control PDU), via the Uu interface, the Uu-MAC (or Uu-RLC) of the relay UE may transmit the information contained in the Uu MAC CE (e.g. the ID of the remote UE and the ID(s) of the DRB(s)), to Uu-SRAP of the relay UE, and the Uu-SRAP of the relay UE may transmit the information to PC5-SRAP. Then a PC5 MAC CE or a PC5 RLC control PDU may be generated and transmitted by PC5-PHY to the remote UE via the PC5 interface. In this way, the information contained in the Uu MAC CE (or the Uu RLC control PDU) from the BS is transmitted over the indirect path.

### Solution 2-5

In this solution, it is proposed that the BS may configure all the duplicated DRBs to the direct path. That is, all duplicated DRBs are configured to Path #2 in FIG. 1.

FIG. 4 illustrates a method performed by a relay UE for wireless communication according to some embodiments of the present disclosure.

In operation 401, the relay UE may receive configuration information associated with a DRB of a remote UE. In operation 402, the relay UE may receive from at least one of a BS or from the remote UE, a first indication indicating activation or deactivation of a simultaneous transmission on multiple paths of the DRB of the remote UE, wherein the multiple paths include at least a direct path and an indirect path.

In some embodiments, the first indication may indicate at least one of the following:
an identifier of a remote UE, for example, the ID of the remote UE may be the remote 101 as shown in FIG. 1;
an identifier of a DRB, for example, the ID of a DRB may be DRB #1, DRB #2, DRB #3 . . .
an identifier of a path, for example, the ID of a path may be Path #1, Path #2 as shown in FIG. 1, or other IDs of the path;
an identifier of a RLC; or
an identifier of a logical channel.

In some embodiments, the first indication is associated with a DRB configured to the direct path, a DRB configured to the indirect path, or both. For example, the first indication may be associated with DRB #1 configured to the indirect path, DRB #2 configured to the direct path, or associated with both DRB #1 configured to the indirect path and DRB #2 configured to the direct path.

In some embodiments, the first indication includes at least one of the following:
a RRC message;
an IE in a RRC message;
DCI;
a MAC CE;
a control PDU of a SRAP layer; or
a control PDU of an RLC layer.

In some embodiments, the relay UE may transmit the control PDU of the SRAP layer to the remote UE; or assemble, reassemble, generate, or regenerate the control PDU of the SRAP layer, and transmit the assembled, reassembled, generated, or regenerated control PDU of the SRAP layer to the remote UE.

In some embodiments, in the case the first indication includes the MAC CE or the control PDU of the RLC layer, the relay UE may generate a second indication based on the first indication, wherein the second indication indicating activation or deactivation of a simultaneous transmission on multiple paths of the DRB of the remote UE and the second indication is identifiable by the remote UE; and transmit the second indication to the remote UE via an interface between the remote UE and the relay UE. For example, in solution 2-4, the MAC layer or the RLC of the relay UE may receive the first indication, which is transmitted via the Uu interface between the BS and the relay UE, and not identifiable by the remote UE. The relay UE may generate the second indication indicating activation or deactivation of a simultaneous transmission on multiple paths of the DRB of the remote UE, which is identifiable by the remote UE, and transmit the second indication to the remote UE.

In some embodiments, the relay UE may transmit a response to the first indication, wherein the response includes at least one of the following: a confirmation of the activation or deactivation; a message; an ACK; or a HARQ ACK; or wherein the response includes at least one of the following: a rejection of the activation or deactivation; a message; a NACK; or a HARQ NACK.

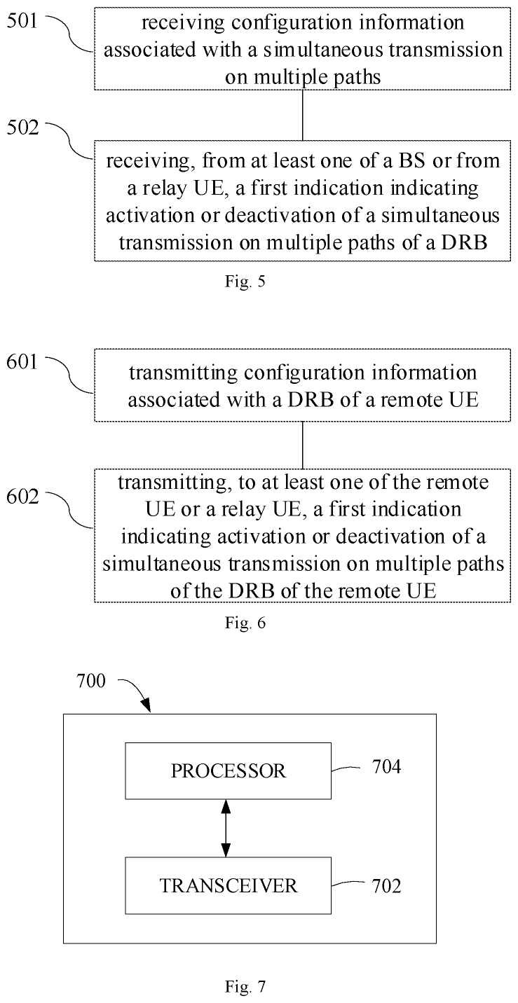

FIG. 5 illustrates a method performed by a remote UE for simultaneous transmission on multiple paths according to some embodiments of the present disclosure.

In operation 501, the remote UE may receive configuration information associated with a simultaneous transmission on multiple paths. In operation 502, the remote UE may receive, from at least one of a BS or from a relay UE, a first indication indicating activation or deactivation of a simultaneous transmission on multiple paths of a DRB, wherein the multiple paths include at least a direct path and an indirect path.

In some embodiments, in the case that the first indication is received from the BS, the remote UE may transmit, to a rely UE, a second indication indicating activation or deactivation of a simultaneous transmission on multiple paths of the DRB. For example, in solution 1-2, the remote UE may transmit an indication indicating activation or deactivation of the configured simultaneous transmission on multiple paths of the remote UE's DRB(s), or activation or deactivation of the configured simultaneous transmission on which path, or activation or deactivation of the configured simultaneous transmission on which path of the remote UE's DRB(s) as described in item (a).

FIG. 6 illustrates a method performed by a BS for simultaneous transmission on multiple paths according to some embodiments of the present disclosure.

In operation 601, the BS may transmit configuration information associated with a DRB of a remote UE. In operation 602, the BS may transmit, to at least one of the remote UE or a relay UE, a first indication indicating activation or deactivation of a simultaneous transmission on multiple paths of the DRB of the remote UE, wherein the multiple paths include at least a direct path and an indirect path.

In some embodiments, the BS may perform a same transmission or different transmissions on the multiple paths to the remote UE.

FIG. 7 illustrates a simplified block diagram of an apparatus for simultaneous transmission on multiple paths according to some embodiments of the present disclosure.

As shown in FIG. 7, an example of the apparatus 700 may include at least one processor 704 and at least one transceiver 702 coupled to the processor 704. The apparatus 700 may be a UE, a remote UE, a relay UE, a U2N relay UE, a U2U relay UE, a U2N and U2U relay UE, a BS, a RAN node, a source node, a target node, a third node, or any other device with similar functions.

Although in this figure, elements such as the at least one transceiver 702 and processor 704 are described in the singular, the plural is contemplated unless a limitation to the singular is explicitly stated. In some embodiments of the present disclosure, the transceiver 702 may be divided into two devices, such as a receiving circuitry and a transmitting circuitry. In some embodiments of the present disclosure, the apparatus 700 may further include an input device, a memory, and/or other components.

In some embodiments of the present disclosure, the apparatus 700 may be a UE. The transceiver 702 and the processor 704 may interact with each other so as to perform the operations of the UE described in any of FIGS. 1-6. In some embodiments of the present disclosure, the apparatus 700 may be a node. The transceiver 702 and the processor 704 may interact with each other so as to perform the operations of the node described in any of FIGS. 1-6.

In some embodiments of the present disclosure, the apparatus 700 may further include at least one non-transitory computer-readable medium.

For example, in some embodiments of the present disclosure, the non-transitory computer-readable medium may have stored thereon computer-executable instructions to cause the processor 704 to implement the method with respect to the UE as described above. For example, the computer-executable instructions, when executed, cause the processor 704 interacting with transceiver 702 to perform the operations of the UE described in any of FIGS. 1-6.

In some embodiments of the present disclosure, the non-transitory computer-readable medium may have stored thereon computer-executable instructions to cause the processor 704 to implement the method with respect to the node as described above. For example, the computer-executable instructions, when executed, cause the processor 704 interacting with transceiver 702 to perform the operations of the node described in any of FIGS. 1-6.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each Fig. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A relay user equipment (UE), comprising:
at least one memory; and
at least one processor coupled with the at least one memory and configured to cause the relay UE to:
receive configuration information associated with a data radio bearer (DRB) of a remote UE; and
receive, from at least one of a base station (BS) or from the remote UE, a first indication indicating activation or deactivation of a simultaneous transmission on multiple paths of the DRB of the remote UE, wherein the multiple paths include at least a direct path and an indirect path.

2. The relay UE of claim 1, wherein the first indication indicates at least one of the following:
an identifier of a remote UE;
an identifier of a DRB;
an identifier of a path;
an identifier of a radio link control (RLC); or
an identifier of a logical channel.

3. The relay UE of claim 1, wherein the first indication is associated with at least one of a DRB configured to the direct path or associated with a DRB configured to the indirect path.

4. The relay UE of claim 1, wherein the first indication includes at least one of the following:
a radio resource control (RRC) message;
an information element (IE) in a RRC message;
downlink control information (DCI);
a media access control control element (MAC CE);
a control protocol data unit (PDU) of a sidelink relay adaptation protocol (SRAP) layer; or
a control PDU of an RLC layer.

5. The relay UE of claim 4, wherein the at least one processor is configured to cause the relay UE to:
transmit the control PDU of the SRAP layer to the remote UE; or
assemble or reassemble the control PDU of the SRAP layer, and transmit the assembled or reassembled control PDU of the SRAP layer to the remote UE.

6. The relay UE of claim 4, wherein, if the first indication includes the MAC CE or the control PDU of the RLC layer, the at least one processor is configured to cause the relay UE to:
generate a second indication based on the first indication, wherein the second indication indicating activation or deactivation a of simultaneous transmission on multiple paths of the DRB of the remote UE and the second indication is identifiable by the remote UE; and
transmit the second indication to the remote UE via an interface between the remote UE and the relay UE.

7. The relay UE of claim 1, wherein the at least one processor is configured to cause the relay UE to:
transmit a response to the first indication,
wherein the response includes at least one of the following: a confirmation of the activation or deactivation; a message; an acknowledge (ACK); or a hybrid automatic repeat request acknowledge (HARQ ACK); or
wherein the response includes at least one of the following: a rejection of the activation or deactivation; a message; an negative-acknowledgement (NACK); or a hybrid automatic repeat request negative-acknowledgement (HARQ NACK).

8. A remote user equipment (UE), comprising:
at least one memory; and
at least one processor coupled with the at least one memory and configured to cause the remote UE to:
receive configuration information associated with a simultaneous transmission on multiple paths; and
receive, from at least one of a base station (BS) or from a relay UE, a first indication indicating activation or deactivation of a simultaneous transmission on multiple paths of a data radio bearer (DRB), wherein the multiple paths include at least a direct path and an indirect path.

9. The remote UE of claim 8, wherein the first indication indicates at least one of the following:
an identifier of a remote UE;
an identifier of a DRB;
an identifier of a path;
an identifier of a radio link control (RLC); or
an identifier of a logical channel.

10. The remote UE of claim 8, wherein the first indication includes at least one of the following:
a radio resource control (RRC) message;
an information element (IE) in a RRC message;
downlink control information (DCI);
a media access control control element (MAC CE);
a control protocol data unit (PDU) of a sidelink relay adaptation protocol (SRAP) layer; or
a control PDU of an RLC layer.

11. The remote UE of claim 8, the first indication is associated with at least one of a DRB configured to the direct path or associated with a DRB configured to the indirect path.

12. The remote UE of claim 8, wherein, if the first indication is received from the base station, the at least one processor is configured to cause the remote UE to:
transmit, to a rely UE, a second indication indicating activation or deactivation of a simultaneous transmission on multiple paths of the DRB.

13. The remote UE of claim 11, wherein the at least one processor is further configured to cause the remote UE to:
receive, from the rely UE, a response to a second indication,
wherein the response includes at least one of the following: a confirmation of the activation or deactivation; a message; an acknowledge (ACK); or a hybrid automatic repeat request acknowledge (HARQ ACK); or
wherein the response includes at least one of the following: a rejection of the activation or deactivation; a message; an negative-acknowledgement (NACK); or a hybrid automatic repeat request negative-acknowledgement (HARQ NACK).

14. A base station, comprising:
at least one memory; and
at least one processor coupled with the at least one memory and configured to cause the base station to:
transmit configuration information associated with a data radio bearer (DRB) of a remote UE; and
transmit, to at least one of the remote UE or a relay UE, a first indication indicating activation or deactivation of a simultaneous transmission on multiple paths of the DRB of the remote UE, wherein the multiple paths include at least a direct path and an indirect path.

15. The base station of claim 14, wherein the at least one processor is configured to cause the base station to:
perform a same transmission or different transmissions on the multiple paths to the remote UE.

16. A processor for wireless communication, comprising:
at least one controller coupled with at least one memory and configured to cause the processor to:
receive configuration information associated with a data radio bearer (DRB) of a remote user equipment (UE); and
receive, from at least one of a base station or from the remote UE, a first indication indicating activation or deactivation of a simultaneous transmission on multiple paths of the DRB of the remote UE, wherein the multiple paths include at least a direct path and an indirect path.

17. The processor of claim 16, wherein the first indication indicates at least one of the following:
an identifier of a remote UE;
an identifier of a DRB;
an identifier of a path;
an identifier of a radio link control (RLC); or
an identifier of a logical channel.

18. The processor of claim 16, wherein the first indication is associated with at least one of a DRB configured to the direct path or associated with a DRB configured to the indirect path.

19. The processor of claim 16, wherein the first indication includes at least one of the following:
a radio resource control (RRC) message;
an information element (IE) in a RRC message;
downlink control information (DCI);
a media access control control element (MAC CE);
a control protocol data unit (PDU) of a sidelink relay adaptation protocol (SRAP) layer; or
a control PDU of an RLC layer.

20. The processor of claim 19, wherein the at least one controller is configured to cause the processor to:
transmit the control PDU of the SRAP layer to the remote UE; or assemble or reassemble the control PDU of the SRAP layer, and transmit the assembled or reassembled control PDU of the SRAP layer to the remote UE.
